(19) United States
(12) Patent Application Publication
(10) Pub. No.: US 2004/0100223 A1
(43) Pub. Date: May 27, 2004

(54) Power supply structure of handheld computer

(76) Inventor: Shen Yuan Chien, Hsin-Tien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/303,969

(22) Filed: Nov. 26, 2002

(51) Int. Cl. H02J 7/00

(52) U.S. Cl. 320/107

(57) ABSTRACT

An improved power supply structure of a handheld computer comprises a battery base, a rechargeable battery connector, and an alkaline battery connector. The battery base is a space for installation of rechargeable or alkaline batteries. The rechargeable battery connector and the alkaline battery connector are made of metal sheets. The rechargeable battery connector stands side by side at the upside in the battery base. The alkaline battery connector is symmetrically arranged at the left and right sides in the battery base. Through arrangement and design of these two kinds of battery connectors, a dual-purpose battery base capable of installing rechargeable batteries or alkaline batteries can be assembled. The user can thus select to use the appropriate power supply structure according to his necessity and convenience.

### FIELD OF THE INVENTION

The present invention relates to an improved power supply structure of a handheld computer and, more particularly, to a dual-purpose battery base for installation of rechargeable batteries or alkaline batteries.

### BACKGROUND OF THE INVENTION

For convenient portability, conventional handheld computers (i.e., portable electronic apparatuses like price inquiring or checking machines used in supermarkets or convenience stores, apparatuses used by police for checking car license plates and identity cards, and personal digital assistants (PDAs) for receiving up-to-the-minute information) use batteries to provide the required electricity. The batteries are rechargeable Li-ion batteries or Ni-MH batteries because they can provide a stable voltage to prevent these electronic delicate apparatuses from damage. Moreover, the charging effect of these rechargeable batteries are very good so that they can be repetitively used, hence meeting the requirements of economy and environmental protection.

However, all the power supply structures of the above handheld computers are designed to only accommodate rechargeable batteries. If one forgets or there is no enough time or he goes out and it is not convenient to recharge these rechargeable batteries, these handheld computers cannot acquire the required electricity for normal operations.

Accordingly, the power supply structures of the above conventional handheld computers have inconvenient and drawbacks in practical use. The present invention aims to resolve the problems in the prior art.

### SUMMARY OF THE INVENTION

The primary object of the present invention is to provide an improved power supply structure of a handheld computer. Through arrangement and design of battery connectors, a dual-purpose battery base capable of installing rechargeable batteries or alkaline batteries can be assembled. The user can thus select to use the appropriate power supply structure according to his necessity and convenience.

To achieve the above object, the present invention provides an improved power supply structure of a handheld computer. The power supply structure comprises a battery base, a rechargeable battery connector, and an alkaline battery connector. The battery base is a space for installation of batteries. The rechargeable battery connector stands side by side at the upside in the battery base. The alkaline battery connector is symmetrically arranged at the left and right sides in the battery base. The rechargeable battery connector and the alkaline battery connector are made of metal sheets.

The various objects and advantages of the present invention will be more readily understood from the following detailed description when read in conjunction with the appended drawing, in which:

### BRIEF DESCRIPTION OF THE DRAWINGS

FIG. 1 is a top view of the present invention;

FIG. 2 is an exploded perspective view showing a first use state of the present invention;

FIG. 3 is a perspective view showing the first use state of the present invention;

FIG. 4 is an exploded perspective view showing a second use state of the present invention; and

FIG. 5 is a perspective view showing the second use state of the present invention.

### DETAILED DESCRIPTION OF THE PREFERRED EMBODIMENTS

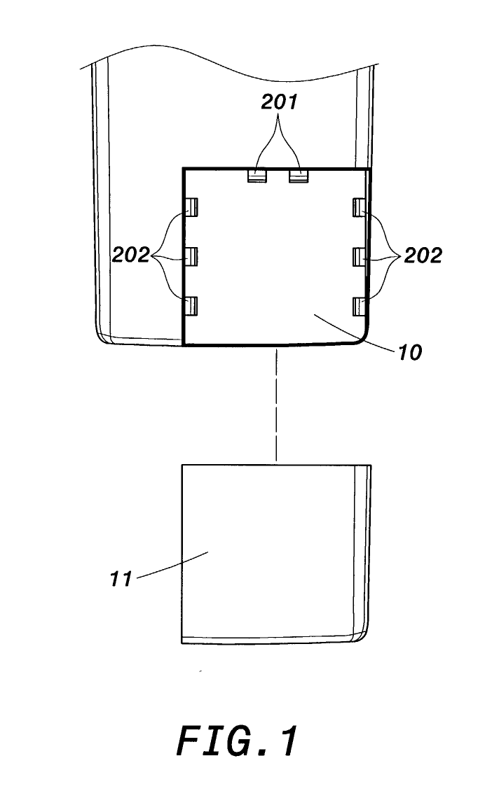

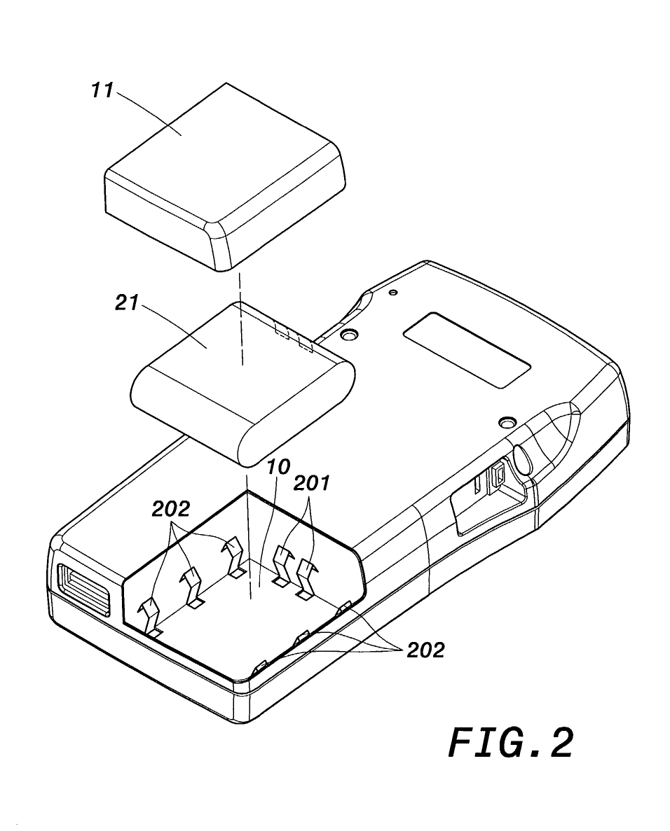

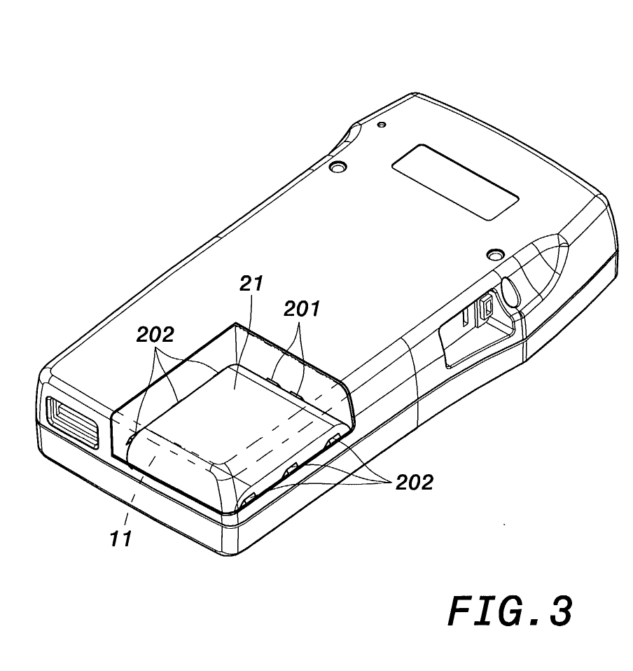

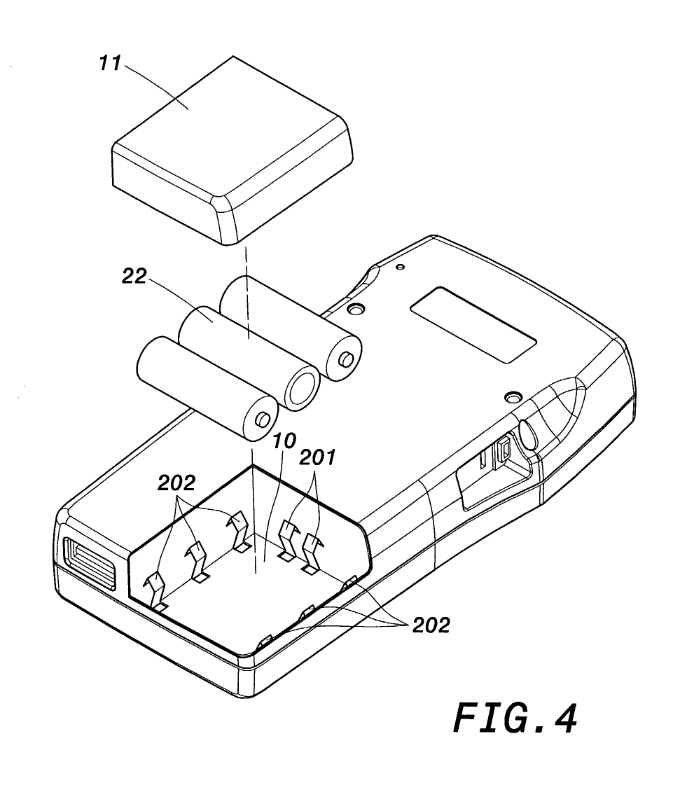

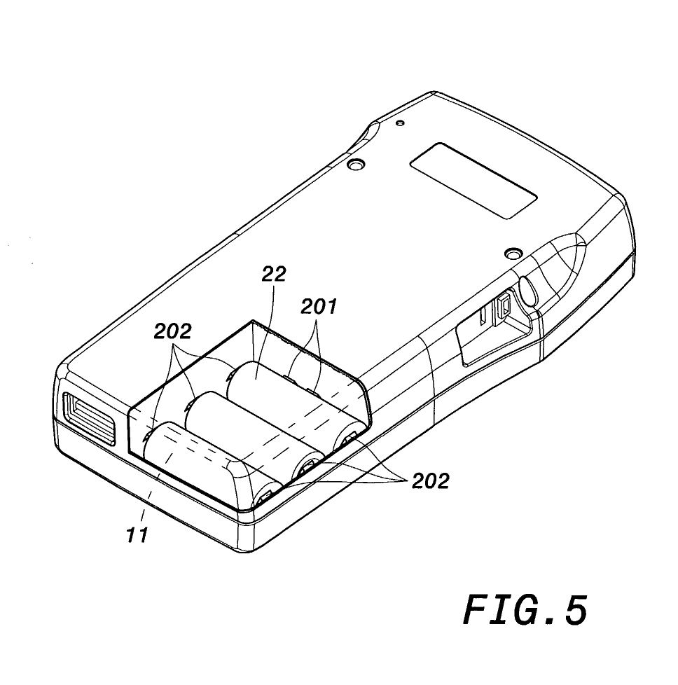

As shown in FIGS. 1 to 5, the present invention provides an improved power supply structure of a handheld computer. The power supply structure comprises a battery base 10, a rechargeable battery connector 201, and an alkaline battery, connector 202. The battery base 10 is disposed at the rear side of a handheld computer. The battery base 10 is a space for installation of rechargeable batteries 21 or alkaline batteries 22. A cover body 11 is disposed above the battery base 10. The cover body 11 is made of plastic material the same as the housing of the handheld computer. The cover body 11 can steadily install batteries in the battery base 10 and keep the integrity of the housing of the handheld computer.

The rechargeable battery connector 201 and the alkaline battery connector, 202 are made of long and thin metal sheets having a good conductivity, and are properly bent into three dimensional structures to tightly retain batteries placed in the battery base 10. The rechargeable battery connector 201 stands side by side at the upside in the battery base 10, and is used for installation of the rechargeable batteries 21. The rechargeable batteries 21 can be Li-ion batteries or Ni-MH batteries. Three pairs of the alkaline battery connectors 202 are symmetrically inserted at the left and right sides in the battery base 10, and are used for installation of the alkaline batteries 22. The rechargeable battery connector 201 and the alkaline battery connector 202 are properly connected with internal circuits of the handheld computer to provide the required electricity for the handheld computer.

To sum up, in addition to having the original power supply structure of a handheld computer, the present invention has also the function of installing alkaline batteries. When one forgets or there is no enough time to recharge the batteries, he can buy alkaline batteries at a nearby electric appliance store or convenience store to solve this, problem.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. An improved power supply structure of a handheld computer, comprising:
a battery base having a space for installation of batteries;
a rechargeable battery connector standing side by side at an upside in said battery base, said rechargeable battery connector being made of metal sheets; and
an alkaline battery connector symmetrically arranged at left and right sides in said battery base, said alkaline battery connector being also made of metal sheets.

2. The improved power supply structure of a handheld computer as claimed in claim 1, wherein said batteries are rechargeable batteries.

3. The improved power supply structure of a handheld computer as claimed in claim 2, wherein said rechargeable batteries are Li-ion batteries or Ni-MH batteries.

4. The improved power supply structure of a handheld computer as claimed in claim 1, wherein the material of said metal sheets has a good conductivity.

5. The improved power supply structure of a handheld computer as claimed in claim 1, wherein a cover body is disposed above said battery base.

6. The improved power supply structure of a handheld computer as claimed in claim 1, wherein said batteries are alkaline batteries.
